(19) United States
(12) Patent Application Publication
(10) Pub. No.: US 2025/0371307 A1
(43) Pub. Date: Dec. 4, 2025

(54) ANSWER CACHING AND KNOWLEDGE CURATION IN RETRIEVAL-AUGMENTED GENERATION APPLICATIONS

(71) Applicant: QlikTech International AB, Lund (SE)

(72) Inventors: Steven Pressland, Borough Green (GB); Adekunle Ajayi, Lyon (FR); Joaquin Duran Toro, Malmo (SE); Stefan Karlsson, Lund (SE); José Díaz López, Lund (SE); Zhiwei Chang, Lund (SE)

(21) Appl. No.: 19/226,317

(22) Filed: Jun. 3, 2025

Related U.S. Application Data
(60) Provisional application No. 63/655,224, filed on Jun. 3, 2024.

(51) Int. Cl. G06N 3/042

(52) U.S. Cl. CPC G06N 3/042

(57) ABSTRACT

A user might submit a question, and an answer could be generated using a knowledge base. User feedback on the answer might be collected and sent for review. Refined knowledge may be determined based on the review. This refined knowledge could be stored in a question and answer (Q&A) source of the knowledge base. New questions might be answered by determining semantic similarity to stored refined knowledge.

### CROSS-REFERENCE TO RELATED PATENT APPLICATION

This application claims priority to U.S. Prov. App. No. 63/655,224, filed on Jun. 3, 2024, the entirety of which is incorporated by reference herein.

### SUMMARY

It is to be understood that both the following general description and the following detailed description are exemplary and explanatory only and are not restrictive.

Described herein are methods, systems, and apparatuses for knowledge curation in question-answering applications. A user might submit a question. An answer could be generated using a knowledge base. User feedback on the answer might be collected and sent for review. Refined knowledge may be determined based on the review. This refined knowledge could be stored in a question and answer (Q&A) source of the knowledge base. Manual questions might be received from subject matter experts (SMEs). Manual knowledge could be generated based on these questions. This manual knowledge may be stored in the Q&A source as well. Semantic similarity might be determined between questions and previously processed questions to retrieve curated answers. Relevant information from other knowledge base sources could be combined with retrieved curated answers. User feedback may include quality ratings of answers. The refined knowledge might be converted into embeddings. These embeddings could be stored in a vector database. New questions might be answered by determining semantic similarity to stored refined knowledge. Other examples are possible as well.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, together with the description, serve to explain the principles of the present methods and systems:

FIG. 1 shows an example system, according to aspects of the present disclosure.

FIG. 2 shows an example system, according to aspects of the present disclosure.

FIG. 3 shows an example system, according to aspects of the present disclosure.

FIG. 4 shows a flowchart of an example knowledge curation workflow, according to aspects of the present disclosure.

FIG. 5 shows an example system, according to aspects of the present disclosure.

FIG. 6 shows a flowchart for an example method, according to aspects of the present disclosure

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers, or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application, reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

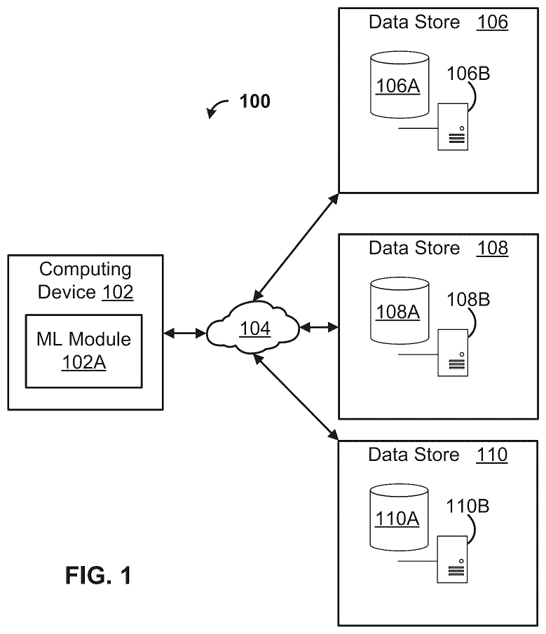

Turning now to FIG. 1, a block diagram of an example system 100 is shown. The system 100 may include a computing device 102 and a plurality of data stores 106, 108, 110 each in communication with the computing device 102 via a network 104. The computing device 102 may comprise a Machine Learning (ML) module 102A. The ML module 102A may comprise and/or facilitate access to a plurality of ML models, such as at least one neural network, at least one Large Language Model (LLM), at least one segmentation model, at least one ensemble model, a combination thereof, and/or the like. Though the ML module 102A is shown in FIG. 1 as being resident at the computing device 102, it is to be understood that the ML module 102A may be resident at one or more computing devices that may be local or remote to the computing device 102. Each of the plurality of data stores 106, 108, 110 may comprise one or more data storage mechanisms, such as a relational database, an in-memory data store, a log, or any other data storage repository configured for a retrieval interface. For ease of explanation, the plurality of data stores 106, 108, 110 may be referred to herein as a “plurality of databases.” It is to be understood that any “database” referred to herein may comprise any type of suitable data storage mechanism.

The network 104 may facilitate communication between the plurality of data stores 106, 108, 110 and the computing device 102. The network 104 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent from any of the plurality of data stores 106, 108, 110 to the computing device 102 via a variety of transmission paths, including wireless paths (e.g., satellite paths, Wi-Fi paths, cellular paths, etc.) and terrestrial paths (e.g., wired paths, a direct feed source via a direct line, etc.). Additionally, data may be sent from the computing device 102 to any of the plurality of data stores 106, 108, 110 via a variety of transmission paths, including wireless paths and terrestrial paths.

The plurality of data stores 106, 108, 110 may be part of a large data storage network consisting of numerous, disparate data stores. For example, the plurality of data stores 106, 108, 110 may be used by an enterprise to store customer data. Each of the plurality of data stores 106, 108, 110 may include a database 106A, 108A, 110A, and a server 106B, 108B, 110B. Each server 106B, 108B, 110B may enable the computing device 102 to communicate with, and retrieve data from, each of the databases 106A, 108A, 110A. Each of the databases 106A, 108A, 110A may be a different type of database. For example, the database 106A may be an Oracle™ database, while the database 108A may be a MySQL™ database.

In some aspects, the system 100 may be adapted to process various types of data sources. For instance, the system 100 may be configured to handle structured data sources. These structured data sources may include databases or spreadsheets, which typically organize data in a structured manner, such as in rows and columns. The computing device 102 may access these structured data sources via the network 104, and the ML module 102A may process the structured data to generate insights or predictions.

In some cases, the system 100 may be adapted to process semi-structured data sources. Semi-structured data sources may include XML or JSON files, which provide some level of data organization through tags and attributes, but do not conform to the rigid structure of databases or spreadsheets. The computing device 102 may access these semi-structured data sources via the network 104, and the ML module 102A may process the semi-structured data to generate insights or predictions.

In other cases, the system 100 may be adapted to process real-time data streams or data feeds. Real-time data streams or data feeds may include data that is continuously generated and transmitted, such as sensor data, social media feeds, or financial market data. The computing device 102 may access these real-time data streams or data feeds via the network 104, and the ML module 102A may process the real-time data to generate insights or predictions in real-time or near real-time. In each of these cases, and as further described herein, the data from the various data sources may be transformed into a format that may be consumed by an LLM.

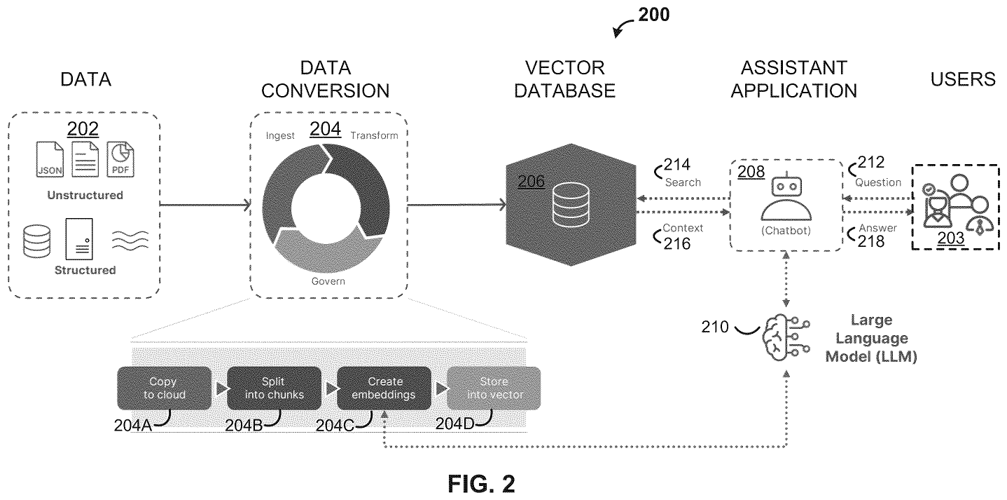

FIG. 2 shows an example system 200. The system 200 may comprise one or more components of the system 100. That is, the capabilities of the system 200 as described herein also apply to the system 100, as the two systems may share—or may each comprise—each described component, resource, device, etc., that performs each of the actions described herein (and potentially not shown). For example, the computing device 102 of system 100 may correspond to a device hosting the RAG application 208 and/or the LLM 210 in system 200. The machine learning module 102A may correspond to the LLM 210 and may perform the embedding generation at step 204C. The network 104 may facilitate communication between the components of system 200, enabling data transfer between the existing data 202, the vector database 206, and the RAG application 208. The data stores 106, 108, 110 may store the existing data 202 and/or may implement the vector database 206. The databases 106A, 108A, 110A may store the embeddings generated at step 204C. The servers 106B, 108B, 110B may execute the data conversion process 204 and may facilitate the search process 214. The system 200 may utilize these components to transform existing data into a format consumable by LLMs and to provide natural language answers to user queries. The capabilities described for system 100 may be accomplished through the interaction of these corresponding components in system 200.

In some aspects, the system 200 may be utilized to transform data 202 into a format that may be consumed by Large Language Models (LLMs). For example, the data 202 may comprise unstructured, file-based sources, such as presentations, mail archives, text documents, PDFs, transcripts, etc. The text of the data 202 may be split into manageable chunks in a data conversion process 204. At step 204A, the data 202 may be copied to a cloud-based environment and split into chunks (e.g., portions of text data) at step 204B. The size of these chunks may vary depending on various factors. For instance, the complexity of the data or the computational resources available may influence the size of the chunks. In some cases, larger chunks may be used if the data is relatively simple and ample computational resources are available. In other cases, smaller chunks may be used if the data is complex or computational resources are limited.

Once the data is split into chunks, each chunk may be converted into an embedding at step 204C. This conversion may be performed by an LLM or another type of machine learning model. Different types of LLMs may be used depending on the specific requirements of the task. In some cases, other machine learning models that are not LLMs may be used to convert the chunks into embeddings. For example, transformer-based models, recurrent neural network models, and/or convolutional neural network models may be used. Transformer-based models, such as BERT (Bidirectional Encoder Representations from Transformers), GPT (Generative Pre-trained Transformer), and T5 (Text-to-Text Transfer Transformer), are particularly well-suited for natural language processing tasks. These models use self-attention mechanisms to process input data, allowing them to capture long-range dependencies and contextual information effectively. Recurrent Neural Network (RNN) models, including Long Short-Term Memory (LSTM) and Gated Recurrent Unit (GRU) networks, are designed to handle sequential data. They maintain an internal state that can capture information from previous inputs, making them useful for tasks involving time-series data or text sequences. Convolutional Neural Network (CNN) models, traditionally used for image processing, have also been adapted for text analysis. They can efficiently capture local patterns and hierarchical features in data, which can be beneficial for certain types of text classification or feature extraction tasks.

In addition to these LLMs, other machine learning models may be employed for creating embeddings. That is, in some cases, one or more other machine learning models that are not LLMs may be used to convert the chunks into embeddings. For ease of explanation, however, these one or more other machine learning LLMs that may be used will be referred to as one or more LLMs. For instance, traditional word embedding models like Word2Vec, GloVe (Global Vectors for Word Representation), or FastText can be used to generate vector representations of words or phrases. Dimensionality reduction techniques such as Principal Component Analysis (PCA) or t-SNE (t-Distributed Stochastic Neighbor Embedding) can also be applied to create lower-dimensional embeddings of high-dimensional data. The choice of model depends on factors such as the nature of the data (e.g., text, numerical, categorical), the specific requirements of the task (e.g., accuracy, processing speed, interpretability), and the available computational resources. In some cases, a combination of different models may be used to combine their respective strengths and create more robust or versatile embeddings.

In some examples, at step 204C, each chunk may be converted into an embedding via an LLM, such as the LLM 210 in FIG. 2. Each embedding may comprise a numerical representation of the corresponding chunk of the data 202 that may be consumed/used by an LLM(s) (e.g., by the LLM 210).

The embeddings may then be stored in a vector database 206 at step 204D. The vector database 206 may then semantically index the embeddings, which involves organizing the numerical representations of the data chunks in a manner that reflects the semantic meaning of the content within each chunk. This semantic indexing may facilitate more efficient and accurate retrieval of information in response to queries. In some aspects, the semantic indexing may use algorithms that understand the context and relationships between different words and phrases within the embeddings, allowing for a more nuanced search capability. The indexing process may also involve the creation of an index map that correlates the embeddings with their respective data chunks, enabling quick access to the original data when a relevant embedding is identified. Additionally, the vector database 206 may employ techniques such as dimensionality reduction to optimize the storage and retrieval of embeddings without losing the semantic relationships within the data.

After embeddings are generated and semantically indexed in the vector database 206, an assistant application 208, such as a natural language (“NL”) assistant and/or a chatbot, may provide NL answers to queries related to the data 202. For example, the assistant application 208 may interact with the LLM 210 to process natural language queries from one or more users. The one or more users 203 may interact with the assistant application 208 via a client device, such as the computing device 102, a mobile device, or a web browser. The assistant application 208 may be designed to provide responses in various formats. In some cases, the assistant application 208 may provide text-based responses. In other cases, the assistant application 208 may provide visual or auditory responses. For example, the assistant application 208 may generate a graphical representation of the response, or it may generate an audio file that verbally communicates the response.

As shown in FIG. 2, the one or more users 203 may send a question 212 (e.g., a NL query) to the assistant application 208. The assistant application 208 may perform a search 212 against the vector database 206 in order to receive context 216 that may be based on the embeddings of the data 202, and the context 216 may be used by the assistant application 208 to provide an answer 218 (e.g., a NL answer/output). In this way, the “knowledge” used by the system 200 to provide answers 218 to searches 212 may be augmented using the data 202, which forms the basis for the context 216 provided to the assistant application 208.

The assistant application 208 may be designed to interact with users in a conversational manner. This may allow for more complex and dynamic interactions between the users 203 and the assistant application 208. For example, the assistant application 208 may be capable of maintaining a conversation with a user over multiple exchanges, keeping track of the context of the conversation and providing responses that are relevant to the ongoing conversation. In some aspects, the assistant application 208 may be integrated with other systems or applications to provide additional functionality. For example, the assistant application 208 may be integrated with a customer relationship management system, a content management system, a data analysis system, or any other type of system or application. This integration may allow the assistant application 208 to access additional data, leverage additional computational resources, or provide additional services to users.

In analytics systems (e.g., SaaS systems), the unstructured, file-based sources that may be used to generate a knowledge base(s) may be contained within one or more “apps” (short for applications). From a technical standpoint, an app in an analytics system is a self-contained environment designed to facilitate data analysis and visualization. It serves as a comprehensive workspace where users can load, manipulate, and analyse data to create interactive reports and dashboards. Within an app, data connections are established to various sources such as databases, spreadsheets, and web services, allowing the importation of data. The app then structures this data into a data model, which includes tables and their relationships. A “data load script” for the app may define how data is imported and transformed within the app. Users may create “sheets” within the app to layout their analyses, populating them with interactive “visualizations” like charts, graphs, and tables that are driven by the underlying data. These visualizations may be standardized using “master items,” ensuring consistency and reusability across the app.

Additionally, users may create one or more “stories” associated with an app, which may be narratives combining visual elements and text to present insights comprehensively. “Bookmarks” associated with an app may allow users to save specific states of the app, capturing selections and filters for quick access to particular views. “Extensions” may enable the addition of custom visualizations and functionalities, enhancing the app's capabilities. An app may also incorporate “security rules” to define access permissions and data visibility, ensuring that users only see the data they are authorized to access.

The vector database 206 may comprise a plurality of knowledge bases. To create a knowledge base from an app, such as for use in a Retrieval-Augmented Generation (RAG) system (e.g., the system 200), the system 200 may retrieve and structure a comprehensive set of data and metadata from the app. This data forms the foundation of the knowledge base, allowing the RAG system to generate accurate and contextually relevant responses to user queries. First, the system 200 gathers details about the data connections, including information about the data sources connected to the app (e.g., the data 202) and the necessary authentication credentials. Understanding the structure of the data model is crucial, so that the system 200 may extract information on the tables and fields imported into the app, the associations between tables, and relevant metadata for each field.

The data load script, which may define how data is imported and transformed, may be captured by the system 200, along with any applied data transformations. Information about the sheets and visualizations within the app, including their layout, types, underlying data, and metadata, may also collected by the system 200. This includes reusable dimensions, measures, and master visualizations defined in the app. The system 200 may also collect the content of any stories or presentations built within the app, including the visualizations and text used, as well as titles, descriptions, and relevant metadata. Additionally, details of saved bookmarks, including selections and filters, may be retrieved by the system 200. If the app uses any custom visualizations or extensions, the system 200 may gather information about these custom objects and their metadata.

To ensure the knowledge base remains current and accurate, the system 200 may periodically capture static data extracts or snapshots of the data used in the app. For example, a purpose-built API(s) may be used by the system 200 to programmatically extract the necessary data and metadata, ensuring that all relevant transformations and calculations are captured. The extracted data may then be organized into a structured format suitable for the knowledge base by the system 200. Including all relevant metadata provides context and enhances the usability of the knowledge base.

Indexing the knowledge base supports efficient retrieval of information, and techniques such as vectorization and semantic search, as performed by the vector database 206, enhance the retrieval capabilities for the system 200. Finally, setting up processes to periodically update the knowledge base with new data and changes from the app ensures the knowledge base remains current and accurate. By extracting and structuring this comprehensive set of information from an app, the system 200 may create—and maintain—a robust knowledge base for a RAG system, enabling it to provide accurate and contextually relevant answers to user queries.

To transform data from an app for use in the system 200, several steps are taken to ensure the data is appropriately structured and accessible for generating accurate and contextually relevant responses. First, data from the app is extracted by the system 200. This includes data from various sources connected to the app, as well as the data model, which comprises tables and their relationships. The data load script and any transformations applied within the app may be replicated by the system 200 to maintain consistency.

Once extracted, the data may be cleaned and pre-processed by the system 200. This may involve handling missing values, normalizing data formats, ensuring that all the transformations applied by the system 200 are consistent, a combination thereof, and/or the like. The goal of data cleaning and pre-processing is to create a structured dataset that the system 200 may easily index and query. Embeddings, which are dense vector representations of the data, may be created by the system 200, capturing the semantic meaning of textual content.

Text data associated with an app, such as descriptions, titles, and narratives, may be processed using Natural Language Processing (NLP) techniques by the large language model (LLM) 210. Models like BERT, GPT, or other transformer-based models may be used by the system 200 to convert this text data into embeddings as well (or in the alternative). For structured data, feature vectors representing all numerical attributes and/or categorical attributes within the structured data may be created by the system 200. Techniques like principal component analysis (PCA) and/or use of one or more autoencoders may be used by the system 200 to reduce dimensionality and create embeddings. The embeddings may then be indexed by the vector database 206. This indexing permits efficient similarity searches, enabling the system 200 to quickly retrieve relevant data points based on the query embeddings.

The embedded data forms a knowledge base, which includes indexed embeddings and associated metadata, ensuring that the context and relationships within the data are preserved by the system 200. Such knowledge bases may be stored in the vector database 206, which for purposes of explanation is shown in FIG. 2 as being a single vector database 206 but in some examples may comprise a plurality of vector databases 206. The system 200 may use knowledge bases stored in the vector database(s) 206 (and/or elsewhere) to generate responses as described herein. When a user's 203 question 212 is received, the system 200 may convert the question 212 into an embedding, retrieve relevant data from the vector database 206 using vector search, and/or generate responses using the assistant application 208. The retrieved data forms a context 216 that is then used to provide a contextually accurate and relevant answer(s) 218.

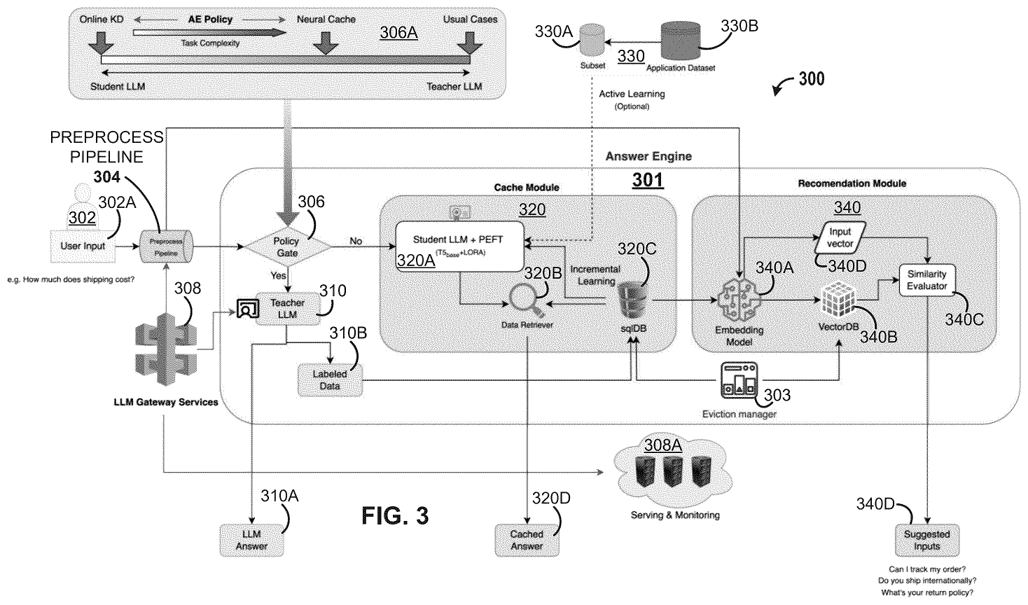

Referring to FIG. 3, a block diagram of an example system 300 for an Answer Engine (AE) 301 is shown. The AE 301 may be a natural language (“NL”) assistant, such as a chatbot, that may provide answers to queries sent by users. The AE 301 may include a teacher LLM 310 and a student LLM 320A. The student LLM 320A may be trained to mimic the teacher LLM 310. As shown in FIG. 3, the student LLM 320A may be within a cache module 320, which may also comprise a cached database 320C, such as an SQL database. The student LLM 320A may use a data retriever 320B to select responses from the cached database 320C. The data retriever 320B may function as a query processor that efficiently searches the cached database 320C for relevant responses based on input from the student LLM 320A, utilizing indexing and search algorithms to quickly locate the closest matching responses for retrieval and potential use as a basis for generating the final answer to a user's 302 query (e.g., user input 302A).

Outputs of the teacher LLM 310, such as the LLM Answer 310A, are ground truth without further verification. Outputs of the teacher LLM 310 may serve as correct responses to user queries and as a benchmark for performance, allowing for a streamlined process where the teacher LLM's 310 outputs directly train and refine the student LLM 320A without additional validation steps. Thus, the system efficiently leverages the expertise of the teacher LLM 310 to maintain the integrity and accuracy of the AE 301, aligning the accuracy of the AE 301 with that of the teacher LLM 310. The teacher LLM 310 acts as the primary source of knowledge and ground truth for the system 300.

A Policy Gate 306 decides on the routing of queries, such as user input 302A, determining whether they are resolvable by the student LLM 320A independently or require input from the teacher LLM 310. The cache module 320 enables the student LLM 320A to learn from the teacher LLM 310 for efficient retrieval in future queries. For example, the cache module 320 may store responses from the teacher LLM 310 that are correct or of high quality, facilitating the incremental learning of the student LLM 320A. This repository of responses allows the student LLM 320A to efficiently handle similar future queries, reducing dependency on the teacher LLM 310 over time. The cache module 320 may also employ algorithms to continuously evaluate and update stored responses based on relevance and accuracy. A recommendation module 340 may suggest relevant queries or information to users 302 based on the context of their current query, such as user input 302A.

Upon receiving user input 302A, ranging from a simple prompt to a complex LLM-chain-prompt, the user input 302A enters a preprocessing pipeline 304 for security checks, input sanitization, context compression, etc., facilitated by LLM gateway services 308, such as one or more purpose-built API(s). The user input 302A then reaches the policy gate 306, which decides on the involvement of the teacher LLM 310 for annotation. The preprocessing pipeline 304 may include a security check module (not shown) to detect and mitigate potential security threats, an input sanitization module (not shown) to cleanse the data, a compression module (not shown) to reduce input data size, a combination thereof, and/or the like. The preprocessing pipeline 304 may also include a module for detecting personally identifiable information (PII) (not shown), which may use pattern recognition algorithms to identify and obfuscate PII within any user input 302A, and a content filtering module (not shown) to detect and remove objectionable language, ensuring all user input 302A is cleansed of sensitive information and inappropriate content before further processing.

The policy gate 306 comprises decision logic 306A, which may use Online Knowledge Distillation (Online KD) to determine whether the student LLM 320A may respond to the user input 302A or whether the teacher LLM 310 is involved for annotation. The student model 320A aims to replicate the teacher LLM's 310 responses 310A, focusing on accuracy. The policy gate 306 tests different user input 302A selection criteria, including random selection, coreset, margin sampling (MS), and query by committee (QBC), and may use a Neural Cache (NC) integrating aspects of the student LLM 320A, the teacher LLM 310, and policy components, aiming to optimize overall accuracy. The user input 302A selection criteria recommended may be MS or QBC in some examples.

The selection by the policy gate 306 between Online KD using the student LLM 320A and the NC may depend on the complexity of the tasks, such as the complexity of the user input 302A. For intricate user inputs 302A involving long text prompts, in-context learning, and LLM chain prompts, the NC strategy may be preferred due to frequent involvement of the teacher LLM 310. Conversely, for simpler user input 302A, the Online KD may be used to replace the teacher LLM 310 with the student LLM 320A. This strategic differentiation ensures that the AE 301 architecture remains adaptable and scalable, capable of addressing a wide spectrum of queries with varying complexity.

When the policy gate 306 deems the student LLM 320A capable of independently handling a user input 302A, the policy gate 306 directs the user input 302A to the cache module 320 to generate a response, such as a cached answer 320D. If the policy gate 306 determines the user input 302A requires the expertise of the teacher LLM 310, the preprocessed user input 302A and the response generated by the teacher LLM 310 are captured as labeled data 310B and stored within the question-and-answer knowledge base, such as the cached database 320C. This process of accumulating labeled data 310 continues until a sufficient volume is collected, at which point a batch of this data is used to fine-tune the student LLM 320A, allowing for continuous training of the student LLM 320A as new data becomes available, ensuring that the AE 301 remains updated and relevant.

The policy gate 306 may mitigate overfitting by preventing the storage of excessively similar data within the cache, the cached database 320C, which would later serve as training material if stored. This safeguard helps maintain the diversity and quality of the data used for training. Through this mechanism, the system 300 may achieve a balance between leveraging existing knowledge through the cached database 320C and adapting to new information through incremental learning.

In some cases, the policy gate 306 may determine not to store an answer provided by the teacher LLM 310 in the cached database 320C if it is too similar to an already-stored answer. For instance, if the teacher LLM 310 generates an answer to a user query, and the cached database 320C already contains a similar answer with nearly identical content, the policy gate 306 may decide against storing the new answer. This decision may be based on a similarity threshold set by the system, which identifies when the semantic content of two answers is substantially the same, thereby preventing redundancy in the cached database 320C. The similarity threshold may be a predefined value that determines an acceptable degree of similarity between two answers. The system 300 may use techniques such as cosine similarity or other measures of semantic similarity to compare the content of two answers, analyzing not just the individual words used but also the overall meaning and context. If the semantic content of two answers exceeds the similarity threshold, indicating substantial sameness, the system 300 may decide against storing the new answer to prevent redundancy and inefficiencies in the cached database 320C.

A subset of the informative examples may be stored in a vector database 340B and used to fine-tune the student LLM 320A. This strategy introduces a cascading Active Learning (AL) phase in the AE 301, reducing performance lag and enabling immediate effectiveness upon deployment. For example, this may be a dynamic process involving continuous selection and utilization of the “most informative” examples to enhance the performance of the student LLM 320A. These examples may be identified based on factors such as relevance, complexity, and/or novelty, etc., allowing the student LLM 320A to learn more effectively and efficiently. This approach may also allow the system 300 to adapt to new information and evolving query patterns, as the “most informative” examples are continuously updated based on incoming user queries and feedback. Moreover, this approach reduces performance lag, enabling the AE 301 to be immediately effective upon deployment.

In some examples, the Neural Cache (NC) may include a collection of “gold-labelled cached answers,” which could be a combination of cached answers 320D and LLM answers 310A. The term “gold-labelled” refers to the high-quality nature of these answers, validated and deemed accurate by the system 300. The inclusion of these gold-labelled cached answers in the NC allows the student model 320A to achieve a performance level comparable to that of the teacher LLM 310. The student LLM 320A may use this curated set of high-quality responses to refine its response generation process, potentially improving accuracy and efficiency in answering user queries, thereby enhancing the overall performance of the system.

Returning to FIG. 3, in some examples the gold-labelled cached answers are processed through an embedding model 340A, which may be a component of a recommendation module 340. The embedding model 340A may convert the textual information from the gold-labelled cached answers into one or more embedding vectors 340, which may comprise numerical representations that capture the semantic meaning of the gold-labelled cached answers. Once generated, these embedding vectors are stored in a vector database 340B for future use. User inputs 302A are also transformed into one or more embedding vectors 340 using the same embedding model 340A, ensuring that both user inputs and gold-labelled cached answers are represented in the same semantic space, facilitating comparison and matching of user queries with relevant answers.

A similarity evaluator 340C may assess the one or more embedding vectors 340 to identify the top-N results that are the closest match to the user's query. The term “top-N” may refer to the N number of results with the greatest similarity to the user's query. The similarity evaluator 340C may use a simple similarity measure, such as cosine similarity, or incorporate an additional layer, such as a fine-tuned ALBERT model, to refine the selection of the top-N results. The top-N results may be presented to the user 302 as suggested inputs 340D, such as recommended prompts. These recommended prompts may provide the user 302 with a list of potential queries or information relevant to their current query, for example.

An eviction manager 303 of the system 300 may handle data storage in both the cached database 320C and the vector database 340B. An example eviction policy carried out by the eviction manager 303 may maintain a fixed number of data records, such as a threshold number of data records. When the current quantity of data records in either the cached database 320C or the vector database 340B exceeds the fixed number, those data records may be evicted or deleted according to their cache hit frequency, such as based on an existing caching policy that includes an eviction policy or similar.

The system 300 also includes a serving and monitoring system 308A, a comprehensive infrastructure providing the computational resources and services the Answer Engine (AE) 301 requires to function effectively. The serving and monitoring system 308A may comprise servers hosting the AE 301 and handling the processing of user queries and generation of responses, such as with high-performance processors, large memory capacities, and fast network interfaces to ensure the AE 301 handles high volumes of queries and delivers responses with low latency. In addition to servers, the serving and monitoring system 308A may include other compute resources supporting the operations of the AE 301, such as storage systems for storing knowledge bases, databases for managing user data and system logs, and network devices for facilitating communication between the AE 301 and users. The serving and monitoring system 308A may monitor the performance and health of the AE 301, as an example, including monitoring tools that track various performance metrics, such as throughput, latency, and error rates. These tools may provide real-time insights into the performance of the AE 301.

The serving and monitoring system 308A may be provided by LLM gateway services 308. For example, the LLM gateway services 308 may be a set of services facilitating interaction between the AE 301 and one or more Large Language Models (LLMs). These services may include API endpoints for submitting queries to the LLMs, data transformation services for converting data into a format consumable by the LLMs, and security services for protecting data and ensuring user privacy.

In some examples, the system 300 may comprise one or more components of the system 200. That is, the capabilities of the system 300 as described herein also apply to the system 200, as the two systems may share—or may each comprise—each described component, resource, device, etc., that performs each of the actions described herein (and potentially not shown). For example, the existing data 202 of system 200 may correspond to the labeled data 310B in system 300. The labeled data 310B may serve as the source material that undergoes transformation for use by the LLMs. The vector database 206 of system 200 may correspond to the vector database 340B in system 300. The vector database 340B may store embeddings generated from the data for efficient retrieval during query processing.

The RAG application 208 of system 200 may correspond to the combination of the policy gate 306 and the cache module 320 in system 300. These components may work together to process user queries and determine the appropriate response generation path. The LLM 210 of system 200 may correspond to either the teacher LLM 310 or the student LLM 320A in system 300, depending on the complexity of the query. The teacher LLM 310 may handle complex queries requiring deep reasoning. The student LLM 320A may handle simpler queries that match patterns in the cached database.

The user question 212 of system 200 may correspond to the user input 302A in system 300. The user input 302A may undergo preprocessing in the preprocessing pipeline 304 before being processed. The search process 214 of system 200 may correspond to the data retriever 320B and similarity evaluator 340C in system 300. These components may perform the retrieval of relevant information from their respective databases. The retrieved context 216 of system 200 may correspond to the data retrieved from the cached database 320C or vector database 340B in system 300. This retrieved data may provide the necessary context for generating accurate responses.

The provided answer 218 of system 200 may correspond to either the LLM answer 310A or the cached answer 320D in system 300, depending on which path the policy gate 306 selects. The LLM answer 310A may be generated for novel or complex queries. The cached answer 320D may be retrieved for previously encountered or simpler queries. The data conversion process 204 of system 200 may be performed by the embedding model 340A in system 300. The embedding model 340A may transform textual data into numerical representations for efficient storage and retrieval.

The LLM gateway services 308 and serving and monitoring system 308A in system 300 may provide the infrastructure support for the entire process described in system 200. These components may facilitate the communication between different parts of the system and monitor performance. The recommendation module 340 in system 300 may enhance the user experience beyond what is explicitly shown in system 200. The recommendation module 340 may suggest related queries to users based on their current interaction with the system.

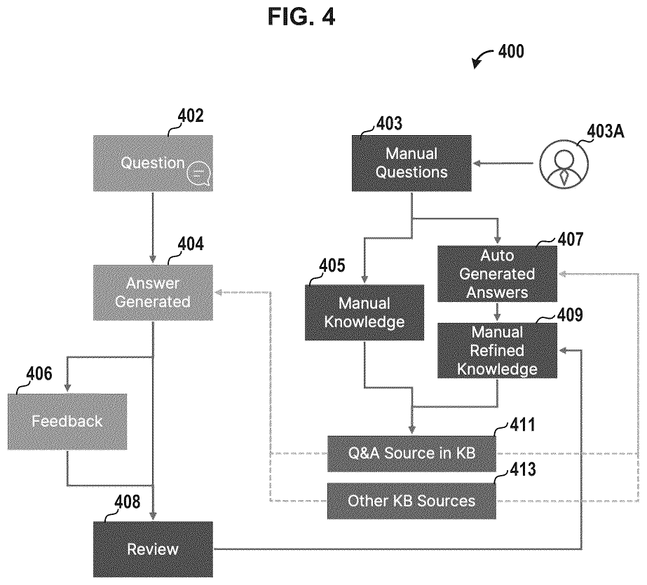

FIG. 4 illustrates a knowledge curation workflow 400 that may be implemented by the system 200 shown in FIG. 2. The workflow 400 may begin when a user 203 submits a question 402 through an interface provided by the RAG application 208. The question 402 may correspond to the user question 212 in FIG. 2. The RAG application 208 may process this question 402 by initiating a search process 214 against the vector database 206. The search process 214 may retrieve relevant context 216 based on the embeddings stored in the vector database 206. The LLM 210 may then use this context 216 to generate an answer 404 that corresponds to the provided answer 218 in FIG. 2.

After receiving the answer 404, the user 203 may provide feedback 406 through the interface of the RAG application 208. The feedback 406 may include a simple indication of whether the answer was helpful, such as a thumbs-up or thumbs-down selection. The feedback 406 may also include more detailed comments or suggestions for improvement. The RAG application 208 may log this feedback 406 along with the question 402 and the answer 404. These three elements—the question 402, the answer 404, and the feedback 406—may collectively form what the workflow 400 refers to as “auto-generated answers” 407.

In parallel to the user-initiated process, a subject matter expert (SME) 403A may interact with the system 200 through an interface provided by the RAG application 208. The SME 403A may define one or more manual questions 403 that may be relevant to users 203. The SME 403A may also create manual knowledge 405 in the form of carefully crafted answers to these manual questions 403. The RAG application 208 may store these manual questions 403 and manual knowledge 405 for future use. The manual knowledge 405 may be processed through the data conversion process 204 to generate embeddings. These embeddings may then be stored in the vector database 206 for future retrieval.

The auto-generated answers 407 may be made available for review 408 by the SME 403A. The review process 408 may be facilitated by the RAG application 208, which may provide an interface for the SME 403A to examine the questions 402, answers 404, and feedback 406. The SME 403A may assess the quality of the answers 404 and may assign a quality ranking to each answer. The SME 403A may also make corrections or improvements to the answers 404 if necessary. The reviewed and potentially refined answers may form what the workflow 400 refers to as “manual refined knowledge” 409.

The manual refined knowledge 409 may be added to a Q&A source in the knowledge base 411. The knowledge base 411 may be implemented as part of the vector database 206 in the system 200. The RAG application 208 may process the manual refined knowledge 409 through the data conversion process 204. This process may involve copying the data to a cloud environment at step 204A, splitting it into chunks at step 204B, converting the chunks into embeddings at step 204C, and storing the embeddings in the vector database 206 at step 204D. The vector database 206 may semantically index these embeddings to facilitate efficient retrieval in response to future queries.

The knowledge base 411 may also include other knowledge base sources 413. These other knowledge base sources 413 may correspond to the existing data 202 in FIG. 2. The existing data 202 may include unstructured, file-based sources such as presentations, mail archives, text documents, PDFs, and transcripts. The existing data 202 may also include structured data from databases or other sources. The system 200 may process this existing data 202 through the data conversion process 204 to generate embeddings. These embeddings may be stored in the vector database 206 alongside the embeddings generated from the manual refined knowledge 409.

When a new question 402 is received from a user 203, the RAG application 208 may determine a semantic similarity between the new question 402 and previously processed questions stored in the knowledge base 411. The RAG application 208 may perform this determination by converting the new question 402 into an embedding using the LLM 210. The RAG application 208 may then compare this embedding to the embeddings stored in the vector database 206. The comparison may be performed using a similarity measure such as cosine similarity. The RAG application 208 may identify one or more curated answers from the manually refined knowledge 409 section of the knowledge base 411 that are semantically similar to the new question 402.

The RAG application 208 may rank the identified curated answers based on their semantic similarity to the new question 402 and their quality rankings assigned by the SME 403A. The RAG application 208 may also identify relevant information from the other knowledge base sources 413. The RAG application 208 may combine the ranked curated answers and the relevant information from the other knowledge base sources 413 to form the context 216. The LLM 210 may use this context 216 to generate a new answer 404 to the question 402.

The workflow 400 may create a feedback loop within the system 200. The user feedback 406 on answers 404 may be used to improve the quality of future answers. The SME review 408 may ensure that incorrect answers are not propagated to further users. The manual refined knowledge 409 may serve as a high-quality source for answering future questions. This feedback loop may allow the system 200 to continuously improve its performance over time. The system 200 may implement the workflow 400 in various ways. The RAG application 208 may provide interfaces for users 203 to submit questions 402 and feedback 406. The RAG application 208 may also provide interfaces for SMEs 403A to define manual questions 403, create manual knowledge 405, and review auto-generated answers 407. The vector database 206 may store the embeddings generated from the manual refined knowledge 409 and the other knowledge base sources 413. The LLM 210 may generate answers 404 based on the context 216 retrieved from the vector database 206. Other examples are possible as well.

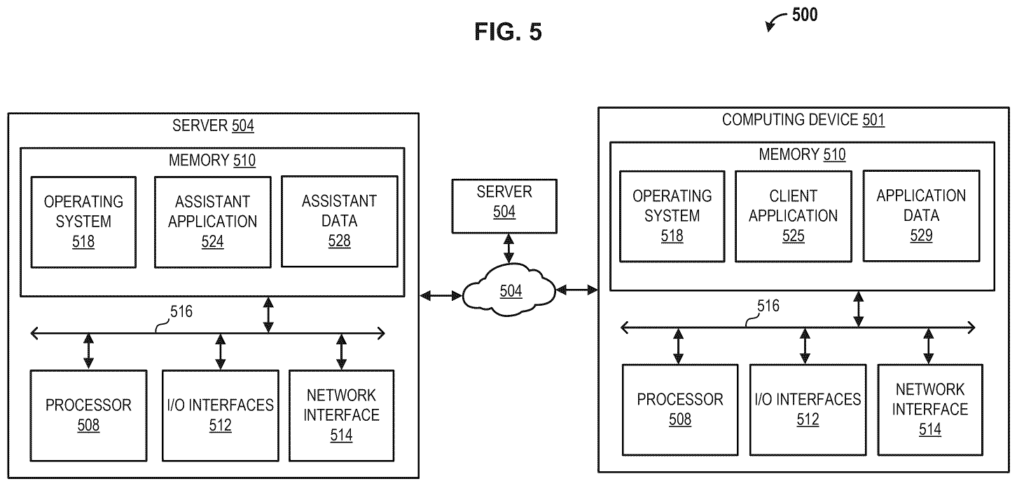

The present methods and systems may be computer-implemented. FIG. 5 shows a block diagram depicting a system/environment 500 comprising non-limiting examples of a computing device 501 and a server 502 connected through a network 504. Either of the computing device 501 or the server 502 may be a computing device, such as any of the devices of the system 100 shown in FIG. 1. In an aspect, some or all steps of any described method may be performed on a computing device as described herein. The computing device 501 may comprise one or multiple computers configured to store application data 529, and/or the like. The server 502 may comprise one or multiple computers configured to store assistant data 529. Multiple servers 502 may communicate with the computing device 501 via the through the network 504.

The computing device 501 and the server 502 may be a digital computer that, in terms of hardware architecture, generally includes a processor 508, system memory 510, input/output (I/O) interfaces 512, and network interfaces 514. These components (508, 510, 512, and 514) are communicatively coupled via a local interface 516. The local interface 516 may be, for example, but not limited to, one or more buses or other wired or wireless connections, as is known in the art. The local interface 516 may have additional elements, which are omitted for simplicity, such as controllers, buffers (caches), drivers, repeaters, and receivers, to enable communications. Further, the local interface may include address, control, and/or connections to enable appropriate communications among the aforementioned components.

The processor 508 may be a hardware device for executing software, particularly that stored in system memory 510. The processor 508 may be any custom made or commercially available processor, a central processing unit (CPU), an auxiliary processor among several processors associated with the computing device 501 and the server 502, a semiconductor-based microprocessor (in the form of a microchip or chip set), or generally any device for executing software instructions. When the computing device 501 and/or the server 502 is in operation, the processor 508 may execute software stored within the system memory 510, to communicate data to and from the system memory 510, and to generally control operations of the computing device 501 and the server 502 pursuant to the software.

The I/O interfaces 512 may be used to receive user input from, and/or for providing system output to, one or more devices or components. User input may be provided via, for example, a keyboard and/or a mouse. System output may be provided via a display device and a printer (not shown). I/O interfaces 512 may include, for example, a serial port, a parallel port, a Small Computer System Interface (SCSI), an infrared (IR) interface, a radio frequency (RF) interface, and/or a universal serial bus (USB) interface.

The network interface 514 may be used to transmit and receive from the computing device 501 and/or the server 502 on the network 504. The network interface 514 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 514 may include address, control, and/or data connections to enable appropriate communications on the network 504.

The system memory 510 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 510 may incorporate electronic, magnetic, optical, and/or other types of storage media. Note that the system memory 510 may have a distributed architecture, where various components are situated remote from one another, but may be accessed by the processor 508.

The software in system memory 510 may include one or more software programs, each of which comprises an ordered listing of executable instructions for implementing logical functions. In the example of FIG. 5, the software in the system memory 510 of the computing device 501 may comprise the application data 529, the client application 525, and a suitable operating system (O/S) 518. In the example of FIG. 5, the software in the system memory 510 of the server 502 may comprise the assistant data 529, the assistant application 524, and a suitable operating system (O/S) 518. The operating system 518 essentially controls the execution of other computer programs and provides scheduling, input-output control, file and data management, memory management, and communication control and related services.

For purposes of illustration, application programs and other executable program components such as the operating system 518 are shown herein as discrete blocks, although it is recognized that such programs and components may reside at various times in different storage components of the computing device 501 and/or the server 502. An implementation of the system/environment 500 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

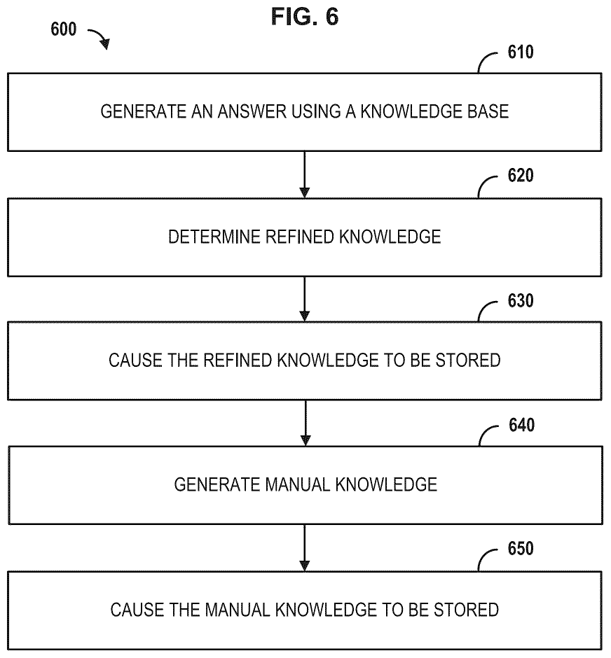

FIG. 6 illustrates a method 600 that may be performed by the system 200 shown in FIG. 2. The method 600 may correspond to the workflow 400 depicted in FIG. 4. The system 200 may utilize various components to execute the method 600, including the RAG application 208, the Large Language Model (LLM) 210, and the vector database 206, as examples. The method 600 may begin with step 610, which involves generating an answer using a knowledge base. This step may be performed by the RAG application 208 in conjunction with the LLM 210. The RAG application 208 may receive a question from a user 203. Upon receiving the question, the RAG application 208 may initiate a search process 214 against the vector database 206. The vector database 206 may contain embeddings generated from various knowledge sources, including manually refined knowledge 409 and other knowledge base sources 413.

The search process 214 may involve determining a semantic similarity between the received question and previously processed questions stored in the knowledge base. This determination may be accomplished by converting the received question into an embedding using the LLM 210. The RAG application 208 may then compare this embedding to the embeddings stored in the vector database 206. The comparison may be performed using a similarity measure such as cosine similarity. Based on this comparison, the RAG application 208 may identify one or more curated answers from the manually refined knowledge 409 section of the knowledge base that are semantically similar to the received question.

In addition to retrieving curated answers, the RAG application 208 may also identify relevant information from other knowledge base sources 413. These other knowledge base sources 413 may correspond to the existing data 202 shown in FIG. 2. The existing data 202 may include unstructured, file-based sources such as presentations, mail archives, text documents, PDFs, and transcripts. The existing data 202 may also include structured data from databases or other sources. The RAG application 208 may combine the retrieved curated answers and the relevant information from other knowledge base sources to form a context 216. This context 216 may be used by the LLM 210 to generate an answer to the user's question. The generated answer may correspond to the answer 404 shown in FIG. 4.

Following the generation of the answer, the method 600 may proceed to step 620, which involves determining refined knowledge. This step may correspond to the feedback and review processes shown in FIG. 4. After providing the generated answer to the user, the system 200 may receive feedback from the user regarding the answer. The feedback may be similar to the user feedback 406 shown in FIG. 4. The feedback may include a rating of the answer's quality provided by the user.

The system 200 may then send the answer and the associated feedback for review. This review process may be similar to the review 408 shown in FIG. 4. The review may be performed by a subject matter expert (SME) 403A. The SME 403A may assess the quality of the answer and may assign a quality ranking to it. The SME 403A may also make corrections or improvements to the answer if necessary. Based on the user feedback and the SME review, the system 200 may determine refined knowledge. This refined knowledge may correspond to the manual refined knowledge 409 shown in FIG. 4. The refined knowledge may represent an improved version of the original answer, incorporating user feedback and expert review.

The method 600 may then proceed to step 630, which involves causing the refined knowledge to be stored. The system 200 may store the refined knowledge in a question and answer (Q&A) source of the knowledge base. This Q&A source may be implemented as part of the vector database 206 in the system 200. To facilitate efficient storage and retrieval, the system 200 may convert the refined knowledge into embeddings. These embeddings may be generated using the LLM 210 or another suitable machine learning model. The generated embeddings may then be stored in the vector database 206. The vector database 206 may semantically index these embeddings to facilitate efficient retrieval in response to future queries.

The method 600 may continue with step 640, which involves generating manual knowledge. This step may correspond to the manual questions 403 and manual knowledge 405 shown in FIG. 4. For example, the system 200 may receive one or more manual questions from an SME 403A. These manual questions may be questions that the SME 403A believes are relevant to users and should have carefully crafted answers. Based on these manual questions, the system 200 may generate manual knowledge. This manual knowledge may be created by the SME 403A and may represent high-quality, expert-curated information. The manual knowledge may be designed to address specific topics or common user queries that require detailed or nuanced responses.

Finally, the method 600 may conclude with step 650, which involves causing the manual knowledge to be stored. Similar to the storage of refined knowledge, the system 200 may store the manual knowledge in the Q&A source of the knowledge base. The manual knowledge may be processed through the data conversion process 204 shown in FIG. 2. This process may involve copying the data to a cloud environment, splitting it into chunks, converting the chunks into embeddings, and storing the embeddings in the vector database 206. Overall, the method 600 may create a feedback loop within the system 200, allowing for continuous improvement of the knowledge base. The user feedback on answers may be used to improve the quality of future answers. The SME review may ensure that incorrect answers are not propagated to further users. The refined knowledge and manual knowledge may serve as high-quality sources for answering future questions.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
generating, based on a question from a user, an answer using a knowledge base;
determining, based on feedback from the user, refined knowledge, wherein the feedback is associated with the answer;
causing the refined knowledge to be stored in a question and answer (Q&A) source of the knowledge base;
generating, based on a manual question associated with a subject matter expert (SME), manual knowledge, wherein the manual question is generated by the SME; and
causing the manual knowledge to be stored in the Q&A source of the knowledge base.

2. The method of claim 1, wherein generating the answer comprises:
determining a semantic similarity between the question and previously processed questions stored in the knowledge base; and
retrieving one or more curated answers based on the semantic similarity.

3. The method of claim 1, wherein generating the answer further comprises:
identifying relevant information from other knowledge base sources; and
combining the relevant information with the retrieved curated answers.

4. The method of claim 1, wherein receiving the feedback comprises receiving a rating of the answer's quality from the user.

5. The method of claim 1, wherein sending the answer and the feedback for review comprises sending the answer and the feedback to the SME for manual review.

6. The method of claim 1, further comprising generating auto-generated answers based on the manual question and the manual knowledge.

7. The method of claim 6, further comprising:
determining, based on the auto-generated answers, additional refined knowledge; and
causing the additional refined knowledge to be stored in the Q&A source of the knowledge base.

8. The method of claim 1, wherein causing the refined knowledge to be stored comprises:
converting the refined knowledge into embeddings; and
storing the embeddings in a vector database associated with the knowledge base.

9. The method of claim 1, further comprising:
receiving a new question from a user;
determining a semantic similarity between the new question and the stored refined knowledge; and
generating a new answer based on the semantic similarity.

10. The method of claim 1, wherein the knowledge base comprises the Q&A source containing the refined knowledge and the manual knowledge and other knowledge base sources containing additional information.

11. An apparatus comprising:
a processor; and
a memory storing instructions that, when executed by the processor, cause the apparatus to:
receive a question from a user;
generate, based on the question, an answer using a knowledge base;
receive feedback from the user regarding the answer;
send the answer and the feedback for review;
determine, based on the review, refined knowledge;
cause the refined knowledge to be stored in a question and answer (Q&A) source of the knowledge base;
receive a manual question from a subject matter expert (SME);
generate manual knowledge based on the manual question; and
cause the manual knowledge to be stored in the Q&A source of the knowledge base.

12. The apparatus of claim 11, wherein the instructions to generate the answer comprise instructions to:
determine a semantic similarity between the question and previously processed questions stored in the knowledge base; and
retrieve one or more curated answers based on the semantic similarity.

13. The apparatus of claim 11, wherein the instructions to generate the answer further comprise instructions to:
identify relevant information from other knowledge base sources; and
combine the relevant information with the retrieved curated answers.

14. The apparatus of claim 11, wherein the instructions to receive the feedback comprise instructions to receive a rating of the answer's quality from the user.

15. The apparatus of claim 11, wherein the instructions to send the answer and the feedback for review comprise instructions to send the answer and the feedback to the SME for manual review.

16. The apparatus of claim 11, wherein the memory stores further instructions that, when executed by the processor, cause the apparatus to generate auto-generated answers based on the manual question and the manual knowledge.

17. The apparatus of claim 16, wherein the memory stores further instructions that, when executed by the processor, cause the apparatus to:
determine, based on the auto-generated answers, additional refined knowledge; and
cause the additional refined knowledge to be stored in the Q&A source of the knowledge base.

18. The apparatus of claim 11, wherein the instructions to cause the refined knowledge to be stored comprise instructions to:
convert the refined knowledge into embeddings; and
store the embeddings in a vector database associated with the knowledge base.

19. The apparatus of claim 11, wherein the memory stores further instructions that, when executed by the processor, cause the apparatus to:
receive a new question from a user;
determine a semantic similarity between the new question and the stored refined knowledge; and
generate a new answer based on the semantic similarity.

20. The apparatus of claim 11, wherein the knowledge base comprises the Q&A source containing the refined knowledge and the manual knowledge and other knowledge base sources containing additional information.
